(19) United States
(12) Patent Application Publication
(10) Pub. No.: US 2025/0205594 A1
(43) Pub. Date: Jun. 26, 2025

(54) HAPTIC FEEDBACK DEVICE AND METHOD OF USE THEREOF

(71) Applicant: Next Level Racing Simulations Pty Ltd, Southport, Queensland (AU)

(72) Inventor: Hessam Ghahramanian, Southport (AU)

(73) Assignee: Next Level Racing Simulations Pty Ltd, Southport, Queensland (AU)

(21) Appl. No.: 18/845,531

(22) PCT Filed: Mar. 9, 2023
(86) PCT No.: PCT/AU2023/050165

§ 371 Date: Sep. 10, 2024

(30) Foreign Application Priority Data
Mar. 11, 2022 (AU) 2022900592

(51) Int. Cl. A63F 13/28; A47C 7/72; A63F 13/803; H02K 7/06

(52) U.S. Cl. CPC A63F 13/28; A47C 7/72; H02K 7/061; A63F 13/803

(57) ABSTRACT

A haptic feedback device and method of use are provided for use with a chair for generating a haptic signal in response to a wired or wireless electrical signal input. The device includes: a planar body including a front surface and an opposed rear surface, said body configured to rest on at least a backrest of the chair and interface an engagement between the chair and an occupant; a plurality of electric actuator assemblies embedded in, and arranged across and along, the planar body and configured to translate the electric signal input into the haptic signal, each assembly of said plurality including an electric actuator, an actuator housing and an enlarged flange portion located on a front side of the actuator housing facing the front surface of the planar body for facilitating transfer of the haptic signal to the occupant via the front surface; and a controller operatively associated with the plurality of electric actuator assemblies for control of the haptic signal generated in response to the wired or wireless electrical signal input.

### TECHNICAL FIELD

The present invention relates to a haptic feedback device and method of use thereof for use with a chair, especially for use with a bucket seat of a simulator cockpit and/or gaming chair.

### BACKGROUND

Video gaming and racing simulators are becoming increasingly popular as a recreational activity. Indeed, the latter is additionally becoming a popular training facility for professional racing drivers, particularly as advancing technology is able to provide increasingly realistic simulated environments.

Generally, a wide range of racing simulators are available ranging from base models simply including a display and a gaming console to high end models including, amongst other items, a base frame, a seat, a pedal set, a steering assembly and one or more motion simulators.

A problem in general with base and lower end models is that the simulators lack the authenticity of a true racing cockpit environment. For example, it is common practice with such models and gaming consoles to use an ordinary chair with the simulator. Of course, such a practice severely detracts from the racing experience creating a disconnect between the occupant and the simulated racing experience.

Further, the cost of upgrading a base or lower end model setup to a more realistic racing cockpit environment is often outside the budget of many racing simulator enthusiasts.

In some instances, an enthusiast may enhance their experience through the use of a haptic feedback device or the like. Such devices are configured to be mounted to a chair and interface an engagement between the occupant and the chair generating haptic signals in response to a wired or wireless electrical signal output from the gaming or racing simulator console.

In use, the haptic signals generated may simulate various realistic forces a professional driver may be exposed to and thus enhance the simulated racing experience. Likewise, the haptic signals generated may generally enhance a user's gaming experience providing further sensory input other than audible and visual feedback already provided.

However, a problem in general with such haptic feedback devices is that they are usually bulky and uncomfortable, particularly when an occupant is resting against the backrest of the chair. As such, it is all too common for a user to remove the device.

It will be clearly understood that, if a prior art publication is referred to herein, this reference does not constitute an admission that the publication forms part of the common general knowledge in the art in Australia or in any other country.

### SUMMARY OF INVENTION

Embodiments of the present invention provide a haptic feedback device and method of use thereof, which may at least partially address one or more of the problems or deficiencies mentioned above or which may provide the public with a useful or commercial choice.

According to a first aspect of the present invention, there is provided a haptic feedback device for use with a chair for generating a haptic signal in response to a wired or wireless electrical signal input, said device including:
a planar body including a front surface and an opposed rear surface, said body configured to rest on at least a backrest of the chair and interface an engagement between the chair and an occupant;
a plurality of electric actuator assemblies embedded in, and arranged across and along, the planar body and configured to translate the electric signal input into the haptic signal, each assembly of said plurality including an electric actuator, an actuator housing and an enlarged flange portion located on a front side of the actuator housing facing the front surface of the planar body for facilitating transfer of the haptic signal to the occupant via the front surface; and
a controller operatively associated with the plurality of electric actuator assemblies for control of the haptic signal generated in response to the wired or wireless electrical signal input.

According to a second aspect of the present invention, there is provided an electric actuator assembly for use with a haptic feedback device, said electric actuator assembly including:
an electric actuator for generating a haptic signal in response to a wired or wireless electrical signal input;
an actuator housing for housing the electric actuator; and
an enlarged flange portion located on a front side of the actuator housing for at least facilitating transfer of the haptic signal to an occupant and/or enhancing user comfort.

Advantageously, the haptic feedback device of the present invention can be used to enhance a gaming or simulated racing experience for prolonged periods without discomfort. The enlarged flange portion provided on the front surface of each actuator housing provides a broader surface to support the load of an occupant thereon while enhancing transmission of a haptic signal through the enlarged flange portion to an occupant. As a result, the haptic feedback device of the present invention does not suffer from the deficiencies of conventional haptic feedback devices in being too bulk and lumpy within the interfacing mat.

As indicated, the haptic feedback device of the present invention is for use with a chair, especially a bucket seat of a simulator cockpit or a gaming chair. It will therefore be convenient to hereinafter describe the haptic feedback device with reference to these example applications. However, a person skilled in the art will appreciate that the haptic feedback device is capable of broader applications and may be used with any chair, such as, e.g., a desk chair, a dining chair, a lounge chair or the like.

Generally, the chair may include a seat base on which an occupant may sit and a backrest extending upwardly from the seat base for supporting a back of the occupant when seated in the chair. The seat base and the backrest may be integrally formed or may be of separate construction and joined together.

In some embodiments, the seat base may be mounted to a racing simulator cockpit frame.

In other embodiments, the seat base may be supported above a support surface by one or more legs extending downward from the seat base.

The seat base may include a pair of opposed surfaces interconnected by opposing edges. The opposed surfaces may include an upper surface on which an occupant may sit and an opposed lower surface. The opposing edges may include a front edge, an opposed rear edge and opposed side edges extending therebetween.

The upper surface may include one or more contours configured to complement the seat of an occupant. For example, in some embodiments, the seat base may include at least one central portion and winged outer edges extending upwardly from the opposed side edges of the seat base. The at least one central portion and the winged outer edges may be of unitary or separate construction, preferably unitary.

The winged outer edges may be of any suitable size and shape to partially enclose an occupant seated atop the seat base.

Like the seat base, the backrest may include a pair of opposed surfaces interconnected by opposing edges. The opposed surfaces may include a front surface against which an occupant may rest and an opposed rear surface. The opposing edges may include an upper edge and opposed side edges between the upper edge and the seat base. In embodiments in which the backrest is of separate construction to the seat base, the backrest may additionally include a lower edge opposite the upper edge.

The front surface may include one or more contours configured to complement an occupant's back, preferably define lumbar support. In some embodiments, the backrest may include at least one central portion and winged outer edges extending forward from the opposed side edges of the backrest, preferably to partially enclose an occupant resting thereon. The at least one central portion and the winged outer edges may be of unitary or separate construction, preferably unitary.

As indicated, the haptic feedback device of the present invention includes a planar body configured to rest on at least the backrest of the chair and interface an engagement between the chair and the occupant, preferably the backrest and the seat base.

The planar body may be of any suitable size, shape and configuration and may be from any suitable material or materials capable of transmitting the haptic signal.

Typically, the planar body may include a pair of opposed surfaces interconnected by opposing edges.

The opposed surfaces may include a rear surface configured to rest upon at least the front surface of the backrest and/or the seat base and an opposed front surface against which an occupant may directly rest. The opposed surfaces may extend substantially parallel to each other.

The opposing edges may include opposed end edges and opposed side edges extending longitudinally between the opposed end edges. The opposed end edges may include an upper end edge configured to face or lie adjacent the upper edge of the backrest and an opposed lower end edge. The opposed lower end edge may preferably lie adjacent the front edge of the seat base.

Generally, the planar body may have a substantially flexible structure. For example, in use, the planar body may be configured to fit to at least the backrest of any chair, preferably the backrest and the seat base, and be rolled or folded when stowed.

In some embodiments, the planar body may be formed from a substantially deformable material or materials, such as, e.g., fabric, plastic and/or rubber material or materials.

In some such embodiments, the planar body may be formed from at least one layer of plastic or rubber foam material or materials, preferably extending longitudinally between the opposed end edges.

In some such embodiments, the planar body may be formed from two or more layers of plastic or rubber foam material or materials arranged substantially atop each other.

In some such embodiments, the planar body may have a substantially deformable and resilient structure formed from one or more layers of foam material or materials, preferably a closed cell form, more preferably a high density closed cell form, such as, e.g., a polyurethane foam. In such embodiments, the planar body may be readily fitted to complementary fit a front surface of a backrest and/or seat base of a chair but may be at least partially resilient such that the planar body does not substantially compress when an occupant rests atop the planar body, particularly during extended periods of use.

The planar body may further include a cover for covering an internal core of the body. The cover may be removable. The cover may be formed from a fabric, plastic, or leather material or materials, preferably a durable, breathable fabric, such as, e.g., vinyl.

The planar body may be configured to be releasably fastened in place atop at least the backrest of the chair, preferably the backrest and the seat base. The planar body may be releasably fastened in any suitable way.

For example, in some embodiments, the planar body may be fastened to the chair with one or more fasteners, such as, e.g., one or more mechanical fasteners and/or chemical fasteners.

In some such embodiments, the one or more mechanical fasteners may include a clip or clamp extending from a lower surface of the planar body and configured to clip or clamp to part of the chair.

In other such embodiments, the one or more mechanical fasteners may include a threaded fastener or the like configured to be extend through an opening defined in the planar body and fasten the planar body to the chair.

In yet other such embodiments, the one or more chemical fasteners may include a wet adhesive, a dry adhesive and/or double sided adhesive tape extending between the rear surface of the planar body and at least part of a front surface of the chair.

In other embodiments, the planar body may be releasably mounted to the backrest and/or seat base of the chair by a connecting mechanism or part thereof. The connecting mechanism or part thereof may be of integral formation with the planar body and the backrest and/or seat base of the chair.

The connecting mechanism may include a first part associated with the rear surface of the planar body and a second part connectable to the first part and associated with the chair.

The connecting mechanism may include mateable male and female formations that couple together, such as, e.g., a threaded connection, an interference (snap-fit) type connection, a bayonet-type connection or a hook-and-loop type connection.

In some such embodiments, the first part of the connecting mechanism associated with the rear surface of the planar body may include a male formation configured to be at least partially inserted into, or coupled with, a female formation of the second part of the connecting mechanism associated with a corresponding part or portion of the chair.

Conversely, in other such embodiments, the first part of the connecting mechanism associated with the planar body may include a female formation configured to at least partially receive, or be coupled with, a male formation of the second part of the connecting mechanism associated with the corresponding part or portion of the chair.

In further embodiments, the planar body may be mounted to the backrest and/or seat base of the chair with at least one fastener including a loop, strap or band.

In some such embodiments, the loop, strap or fastener may extend from the planar body and be configured to be at least partially wound or wrapped around or about the backrest and/or seat base of the chair.

The loop, strap or band may extend from the planar body to a free end, preferably from a side edge of the planar body to the free end.

The loop, strap or band may be of any suitable length extending from the side edge to the free end to extend around at least the backrest of the chair and be secured in place. For example, the loop, strap or band may have a length of between about 100 mm and about 750 mm, preferably between about 300 mm and about 600 mm.

When extending around or about the backrest and/or seat base of the chair, the loop, strap or band may be secured in place by a securing mechanism. The securing mechanism may be of any suitable size, shape and construction and may be operatively associated with the loop, strap or band in any suitable way.

In some embodiments, the securing mechanism may include a buckle or clasp operatively associated with a proximal end of the loop, strap or band and configured to secure the free end of the loop, strap or band, preferably releasably.

Conversely in other embodiments, the securing mechanism in the form of a buckle or clasp may be operatively associated with the free end of the loop, strap or band and configured to secure the free end to a remainder of the loop, strap or band, preferably releasably.

For example, in some such embodiments, the loop, strap or band may include one or more openings extending in a spaced arrangement at least partially along a length of the loop, strap or band, and a prong or male formation of the buckle or clasp may be configured to be selectively inserted into one of the openings to secure the loop, strap or band in place.

In other embodiments, the securing mechanism may be in the form of a hook-and-loop fastening system including at least one hook fastener portion and at least one loop fastener portion configured to be releasably fastened together.

The hook-and-loop fastener system may include one of a hook fastener portion and a loop fastener portion associated with one side of the loop, strap or band and the other of the hook fastener portion and the loop fastener portion associated with an opposite side of the loop, strap or band.

In some such embodiments, the respective portions may extend at least partially along a length of each side of the loop, strap or band, preferably extending entirely along the length of each side.

In other such embodiments, each side of the loop, strap or band may include more than one respective discrete fastener portion, preferably arranged in a spaced arrangement along the length of the side of the loop, strap or band.

In use, the loop, strap or band may be wound or wrapped around or about the backrest and/or seat base of the chair and secured in place through engagement of the at least one hook fastener portion and the at least one loop fastener portion provided on opposite sides of the loop, strap or band.

In other such embodiments, the planar body may include at least one pair of opposed loops, straps or bands extending from opposite side edges and configured to at least partially extend around or about the backrest and/or seat base of the chair and be fastened together, preferably releasably.

The pairs of opposed loops, straps or bands may be fastened together by a securing mechanism as previously described, preferably a hook-and-loop fastening system. Preferably, one of each pair of opposed loops, straps or bands may include at least one hook fastener portion defined thereon and the other of the pair of opposed loops, straps or bands may include at least one loop fastener portion defined thereon.

In some embodiments, the loops, straps or bands may include an adjuster for adjusting a length of the loop, strap or band.

As indicated, the haptic feedback device includes a plurality of electric actuator assemblies embedded in, and arranged across and along, the planar body, preferably in discrete locations. Each electric actuator assembly includes an actuator configured to translate an electric signal input into a haptic signal.

Each electric actuator may be of any size, shape and construction and may be formed from any material or materials capable of generating a haptic signal in response to a wired or wireless electrical signal output. Any suitable type of actuator may be used. The actuator may be electrically actuated. Preferably, each actuator may be an electromechanical device.

For example, the electric actuator may be selected from any one of an eccentric rotating mass (ERM), a linear resonant actuator (LRA), a piezo haptic actuator, a thermoelectric device, a solenoid actuator and an ultrasonic transducer or sensor.

In some embodiments, each electric actuator may include a speaker configured to emit soundwaves in response to a wired or wireless electrical signal input. The emitted soundwaves may generate vibrations and thereby a haptic signal.

In other embodiments, each electric actuator may include a piezo haptic actuator configured to generate a plurality of physical displacement strokes in response to a wired or wireless electrical signal input. The emitted strokes may generate vibrations and thereby a haptic signal.

In yet other embodiments, each electric actuator may include an eccentric rotating mass (ERM) actuator. In such embodiments, each actuator may include an electric motor having a drive shaft and an unbalanced mass mounted to the drive shaft. The unbalanced mass may include a cam or the like.

In yet further embodiments, each electric actuator may include a “taptic engine.”

The device may include any suitable number of electric actuator assemblies. For example, the device may include at least two, at least three, at least four, at least five, at least six, at least seven, at least eight, at least nine or even at least 10 assemblies embedded in, and arranged across and along, the planar body. Preferably, the plurality of assemblies may include eight actuator assemblies arranged in pairs extending along, or near, the opposed side edges of the planar body.

As indicated, each electric actuator assembly further includes an actuator housing and an enlarged flange portion located on a front side of the housing facing the front surface of the planar body for facilitating transfer of the haptic signal generated by the electric actuator to the occupant via the front surface.

The housing may be of any suitable size, shape and construction to at least partially house the electric actuator and transmit the haptic signal from the electric actuator.

The housing may be of unitary construction or may be formed from two or more pieces joined together, preferably the latter.

The actuator housing may be formed from metal or plastic material or materials, preferably plastic material.

The housing may include a rear housing portion configured to face a rear surface of the planar body and an opposed front housing portion configured to face a front surface of the planar body. The portions may couple together in a rim-to-rim arrangement to substantially enclose and house the electric actuator.

The rear housing portion may include a base, a rim and at least one sidewall extending from the base to the rim. The rim may extend from an outer portion of the at least one sidewall and may extend along an edge of the at least one sidewall. The base may be of any suitable shape. In some embodiments, the base may have a circular or oval shape. In other embodiments, the base may have a triangular, rectangular, pentagonal, hexagonal, or octagonal shape. In preferred embodiments, the rear housing portion may include a rectangular-shaped base with four sidewalls extending from the base to the rim.

Like the rear housing portion, the front housing portion may include a base, a rim and at least one sidewall extending from the base to the rim. The rim may extend from an outer portion of the at least one sidewall and may extend along an edge of the at least one sidewall. The base may be of any suitable shape but typically will be of matching shape as the base of the rear housing portion. In preferred embodiments, the front housing portion may include a rectangular-shaped base with four sidewalls extending from the base to the rim.

As indicated, the rear housing portion and the front housing portion may connect together in a rim-to-rim arrangement to form the housing. The portions may connect together in any suitable way.

In some embodiments, the portions may connect together by a connecting mechanism or part thereof. The connecting mechanism or part thereof may be of integral formation with each portion.

The connecting mechanism may include a first part associated with the rear housing portion and a second part connectable to the first part and associated with front housing portion.

The connecting mechanism may include mateable male and female formations that couple together, such as, e.g., a threaded connection, an interference (snap-fit) type connection, a bayonet-type connection or a hook-and-loop type connection.

In some such embodiments, the first part of the connecting mechanism associated with the rear housing portion may include a male formation extending forward from the rim of the rear housing portion and configured to be at least partially inserted into, or coupled with, a female formation of the second part of the connecting mechanism associated with the rim of the front housing portion.

Conversely, in other such embodiments, the first part of the connecting mechanism associated with the rear housing portion may include a female formation configured to at least partially receive, or be coupled with, a male formation of the second part of the connecting mechanism extending forward from the rim of the front housing portion.

In preferred embodiments, each of the rear and front housing portion may include one or more resilient lugs protruding outward from the rim of a respective housing portion and configured to be received and retained in a receiving opening defined in a rim of the corresponding housing portion to thereby connect and retain the housing portions together in a rim-to-rim arrangement.

As indicated, the front housing portion may additionally include an enlarged flange portion.

In some embodiments, the flange portion may extend or protrude outwardly from the base of the front housing portion, preferably co-planar with the base. The flange portion may extend at least partway around and outwardly from the at least one sidewall, preferably entirely around and in an orthogonal orientation relative to the at least one sidewall.

In other embodiments, the flange portion may be defined by a plate extending across and along an outer surface of the base of the front housing portion. In such embodiments, the outer edges of the plate may correspond to the enlarged flange portions and may protrude past the sidewalls of the front housing portion, preferably again in an orthogonal orientation relative to the sidewalls.

Advantageously, when the plurality of electric actuator assemblies are arranged in the planar body with the enlarged flange portion facing the front surface, the actuator assemblies are much more comfortable than conventional actuator assemblies. Further, the enlarged flange portions provide superior transmission of haptic signals than conventional actuator housings lacking an enlarged flange portion.

The plurality of electric actuator assemblies may be arranged across and along the front surface of the elongate body in any suitable arrangement to provide desired haptic signals.

For example, when used with racing simulator cockpits, it may be desirable to have the actuator assemblies alongside edges of the planar body to simulate centrifugal or banking forces when turning. Likewise, it may be desirable to have some actuator assemblies extending centrally along a height of the planar body to simulate accelerating forces, and/or any other in game actions.

In some embodiments, the plurality of electric actuator assembles may be arranged in pairs extending along the opposed side edges of the planar body.

In some embodiments, each actuator assembly may be mounted in pre-formed pockets defined in the planar body. The pockets may be arranged in discrete locations on the planar body.

Each pocket may be sized and shaped to at least partially receive an actuator assembly, preferably such that the enlarged flange portion lies substantially flush with the front surface of the planar body.

As indicated, the haptic feedback device further includes a controller for controlling the plurality of electric actuator assemblies and the haptic signal generated in response to the wired or wireless electrical signal.

The controller may be operatively associated with each of the plurality of electric actuator assemblies, preferably by wired connection, although wireless connections are also envisaged.

The controller may be of any suitable, shape and construction to function as a bridge between the plurality of electric actuator assemblies and the wired or wireless electrical signal input.

The controller may include a processing device, including one or more processors and one or more memory units containing executable instructions/software to be executed by the one or more processors, such as, e.g., a microcomputer.

The controller may be connectable to a signal output device, such as, e.g., a gaming console, PC or the like, to receive the wired or wireless electrical signal input.

In embodiments in which the device receives wired electrical signal input, the controller may include at least one plug for connecting with a port of a signal interface of the signal output device.

The at least one plug may include any suitable plug for connecting with a corresponding port of the signal output device. For example, the plug may include any one of an optical plug, an analog plug, an RCA connector plug, a USB plug, a USB-C plug, a FireWire plug, a DisplayPort plug, a Mini DisplayPort plug, an Apple Display Connector plug, a 30-pin dock plug, a Lightning plug, an HDMI plug or a micro-USB plug.

In some embodiments, the controller may include more than one plug. For example, the controller may include two plugs, three plugs, four plugs or even five plugs. In such embodiments, the controller may include a combination of different plug types enabling the controller to be connected to ports of different signal output devices. For example, in some such embodiments, the device may include an HDMI plug and a USB-C plug.

In embodiments in which the devices receives a wireless electrical signal input, the controller may include a communications module for wirelessly connecting the controller to a signal output device, such as, e.g., a gaming console. The communications module may be in the form of a wireless communications module, such as, e.g., a wireless network interface controller, such that the controller may wirelessly connected to the signal output device via a wireless communications network (e.g., Wi-Fi (WLAN) communication, Satellite communication, RF communication, infrared communication, or Bluetooth™).

The device may include at least one power source for powering the plurality of actuator assemblies and the controller.

In some embodiments, the power source may include an on-board power source, such as, e.g., one or more batteries, preferably associated with the controller.

In other embodiments, the power source may include a mains supply, preferably connectable via the controller.

In some embodiments, the controller may further include one or more keys, buttons, switches and/or dials for a user to control operation of the device.

For example, in some embodiments the controller may include a dial enabling a user to increase/decrease an intensity of the haptic signal generated.

Likewise, in some embodiments the controller may include one or more buttons enabling a user to select specific actuator assemblies.

In some embodiments, the controller may include at least one display for displaying operational data from the device, such as, e.g., an actuator assembly selected or the intensity level.

In some embodiments, the device may further include software configured to be run on an external processing device for interacting with the device, preferably the controller of the device.

The external processing device may include a computer, a tablet, a smart phone, a smart watch or a PDA, for example.

In some such embodiments, the software may include an app configured to be run on a mobile said external processing device, such as, e.g., a tablet or smart phone.

In other embodiments, the software may be a software program, browser extension and/or plug-in extension configured to be run on the external processing device, such as, e.g., a computer.

According to a third aspect of the present invention, there is provided a method of using a haptic feedback device with a chair, said method including:
providing the haptic feedback device of the first aspect;
mounting the planar body of the device to at least a backrest of the chair such that the body interfaces an engagement between the chair and an occupant;
generating one or more haptic signals in response to a wired or wireless electrical input signal with a plurality of electric actuator assemblies embedded in, and arranged across and along, the planar body; and
optionally, controlling the one or more haptic signals generated by way of a controller operatively associated with the plurality of electric actuator assemblies.

The method may include one or more characteristics or features of the device and assembly as hereinbefore described.

The mounting may include aligning the planar body relative to at least the backrest of the chair, preferably also the seat base.

The mounting may include releasably fastening the device relative to the chair.

The generating one or more haptic signal may include causing the plurality of electric actuator assemblies to selectively actuate in response to the wired or wireless electrical signal input.

In some embodiments, the electrical signal input may generally be orchestrated by the software driving the simulated racing experience or game play of the signal output device, i.e., the gaming console and/or PC.

In other embodiments, the electrical signal input may generally correspond to audio associated with the signal output device.

The controlling may include using the controller to adjust an intensity of the haptic signal generated and/or the electric actuator assemblies selected to generate the haptic signal. For example, in some embodiments the controller may include a dial for adjusting an intensity of the haptic signal generated by one or more of the actuator assemblies. Likewise, in other embodiments, the controller may include one or more keys, buttons or dials for selecting one or more of the plurality of actuator assemblies and adjusting the intensity of the actuator assemblies selected.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 is an upper perspective view of a haptic feedback device according to an embodiment of the present invention fitted to a chair;

FIG. 2 is a planar view of the haptic feedback device as shown in FIG. 1;

FIG. 3 is an upper perspective view of the haptic feedback device as shown in FIGS. 1 and 2;

FIG. 4 is a side view of an electric actuator assembly of the haptic feedback device as shown in FIGS. 1 to 3;

FIG. 5 is an exploded view of the electric actuator assembly as shown in FIG. 4.

### DETAILED DESCRIPTION

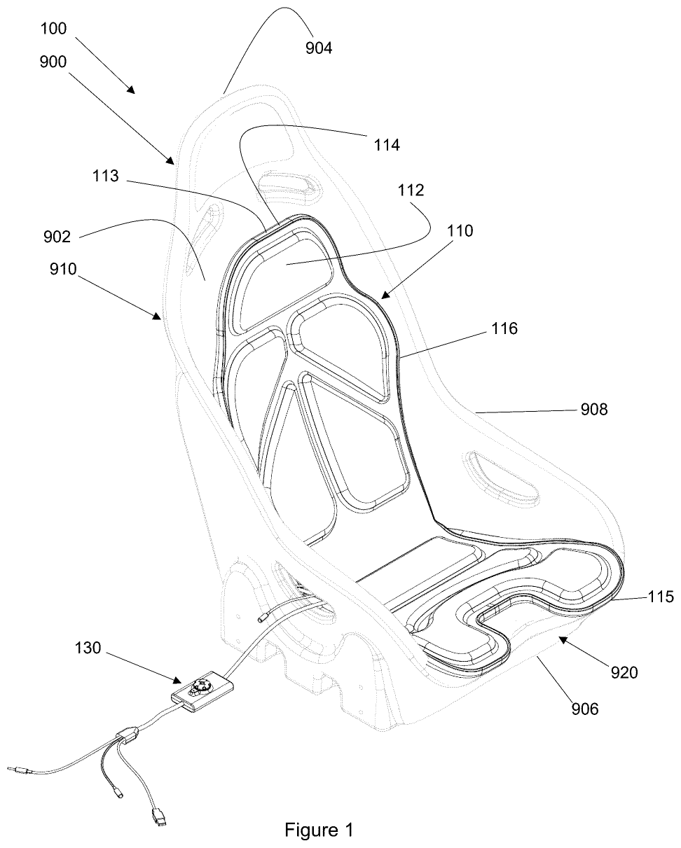

FIGS. 1 to 5 show a haptic feedback device (100) and parts thereof according to an embodiment of the present invention.

Referring to FIG. 1, the haptic feedback device (100) is for use with a bucket chair (900) for generating a haptic signal in response to a wired or wireless electrical signal input from a signal output device, such as, e.g., a gaming console.

The device (100) includes a planar body (110) including a front surface (112) and an opposed rear surface (114). The body (110) is configured to rest atop the backrest (910) and seat base (920) of the chair (900) and interface an engagement between the chair (900) and an occupant.

The device (100) includes four pairs of electric actuator assemblies (120; not shown) that are embedded in, and arranged across and along, the planar body (110).

The assemblies (120; not shown) are configured to translate the electric signal input into a haptic signal. Each assembly (120; not shown) including an electric actuator (122; not shown), an actuator housing (124; not shown) and an enlarged flange portion (126; not shown) located on a front side of the actuator housing (124; not shown) facing the front surface (112) of the planar body (110) for facilitating transfer of the haptic signal to the occupant via the front surface (112) of the planar body (110).

The device (100) further includes a controller (130) operatively associated with the plurality of electric actuator assemblies (120; not shown) for control of the haptic signal generated in response to the wired or wireless electrical signal input.

As indicated, the bucket chair (900) includes a seat base (920) on which an occupant can sit and a backrest (910) extending upwardly from the seat base (920) for supporting a back of the occupant when seated in the chair (900). The seat base (920) and the backrest (910) are integrally formed.

The chair (900) include an upper surface (902) on which an occupant sits. The upper surface (902) is bordered by an upper edge (904), an opposed lower, forward edge (906) and opposed side edges (908) extending therebetween.

As indicated, the planar body (110) of the haptic feedback device (100) is configured to rest on the upper surface (902) of the chair (900) and interface the engagement between the chair (900) and the occupant.

The front surface (112) and opposed rear surface (114) of the planar body (110) are interconnected by opposing edges.

The opposing edges include opposed end edges and opposed side edges (116) extending longitudinally between the opposed end edges. The opposed end edges include an upper end edge (113) configured to face or lie adjacent the upper edge (904) of the chair (900) and an opposed lower end edge (115) configured to face or lie adjacent the lower, forward edge (906) of the chair (900).

The planar body (110) has a substantially flexible structure and is configured, in use, to readily fit the upper surface (902) of a chair (900) and be rolled or folded when stowed.

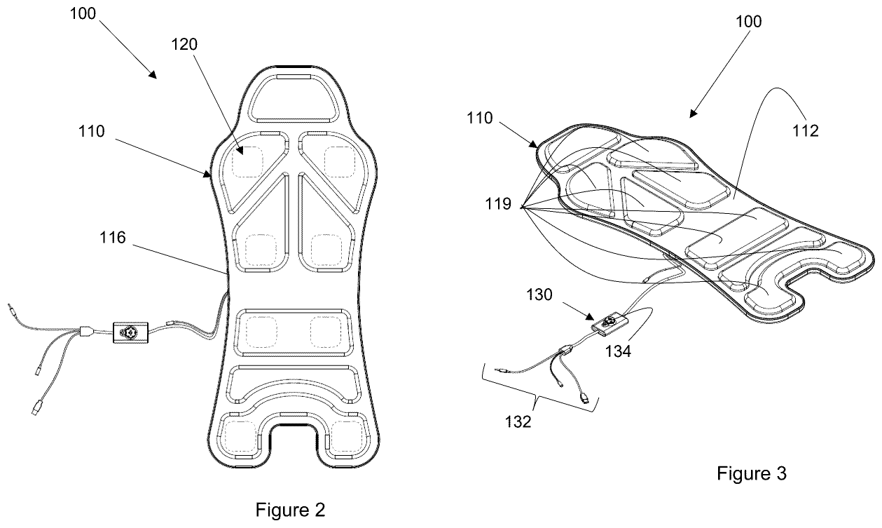

Referring to FIG. 2, the planar body (110) has a substantially deformable and resilient structure formed from one or more layers of a high density closed cell foam, such as, e.g., a polyurethane foam.

The planar body (110) further includes a cover for covering an internal core of the body. The cover is formed from a durable, breathable fabric, such as, e.g., vinyl, and is heat moulded to the internal core.

As indicated, the haptic feedback device (100) includes eight electric actuator assemblies (120) embedded in, and arranged across and along the opposed side edges (116) of, the planar body (110).

Referring to FIG. 5, and as indicated above, each electric actuator assembly (120) includes an electric actuator (122), an actuator housing (124) and an enlarged flange portion (126) located on a front side of the actuator housing (124).

The electric actuator (122) is an eccentric rotating mass (ERM) type actuator. The actuator (122) includes an electric motor having a drive shaft and an unbalanced mass mounted to the drive shaft. The unbalanced mass is a cam configured to cause vibrations when rotated and thus generate a haptic signal when activated.

The actuator housing (124) is formed from plastic. The housing (124) includes a rear housing portion (140) configured to face a rear surface (114; not shown) of the planar body (110; not shown) and an opposed front housing portion (150) configured to face the front surface (112; not shown) of the planar body (110). The portions (140, 150) couple together in a rim-to-rim arrangement to substantially enclose and house the actuator (122).

The rear housing portion (140) includes a base (142), a rim (144) and four sidewalls (146) extending from the base (142) to the rim (144). The rim (144) extends from and along an outer portion of the sidewalls (146).

Like the rear housing portion (140), the front housing portion (150) includes a base (152), a rim (154) and four sidewalls (156) extending from the base (152) to the rim (154). The rim (154) extend from and along an outer portion of the sidewalls (156).

Each of the rear and front housing portions (140, 150) further include two resilient lugs (148, 158) protruding outwardly from the rim (144, 154) of a respective housing portion (140, 150) and configured to be received and retained in a receiving opening (149, 159 (the latter of which is not visible)) defined in the rim (144, 154) of the corresponding housing portion (140, 150) to thereby connect and retain the housing portions (140, 150) together in the rim-to-rim arrangement.

As also shown, the front housing portion (150) additionally includes the enlarged flange portion (126).

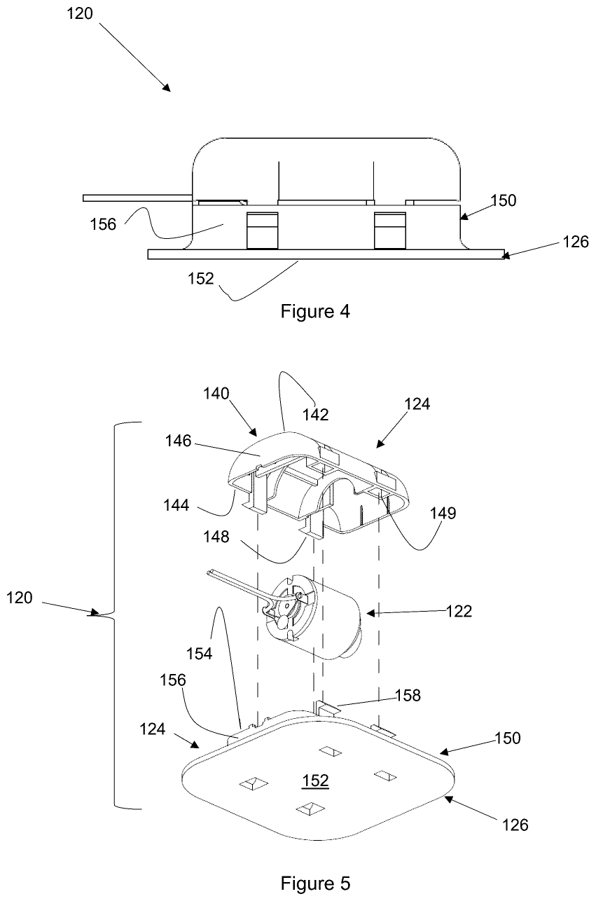

Referring to FIG. 4, the flange portion (126) extends or protrudes outwardly from the base (152) of the front housing portion (150) in a co-planar arrangement with the base (152). The flange portion (126) extends entirely around and outwardly from the sidewalls (156) in an orthogonal orientation relative to the sidewalls (156).

Referring to FIG. 3, when the plurality of electric actuator assemblies (120; not visible) are arranged in the planar body (110) with the enlarged flange portions (126; not visible) facing the front surface (112), the actuator assemblies (120; not visible) are much more comfortable than conventional actuator assemblies. Further, the enlarged flange portions (126; not visible) provide superior transmission of haptic signals than conventional actuator housings lacking an enlarged flange portion.

The electric actuator assemblies (120; not visible) are mounted in pre-formed pockets (119) defined in the planar body (110). The pockets (119) are arranged in discrete locations on the planar body (110).

Each pocket (119) is sized and shaped to at least partially receive an actuator assembly (120; not visible) such that the enlarged flange portion (126; not visible) lies substantially flush with the front surface (112) of the planar body (110).

As indicated, the haptic feedback device (100) further includes a controller (130) for controlling the electric actuator assemblies (120; not visible) and the haptic signal generated in response to the wired or wireless electrical signal.

The controller (130) is connected to the electric actuator assemblies (120) by a wired connection.

In use, the controller (130) functions as a bridge between the electric actuator assemblies (120) and the wired or wireless electrical signal input.

The controller (130) includes a processing device, including one or more processors and one or more memory units containing executable instructions/software to be executed by the one or more processors, such as, e.g., a microcomputer.

The controller (130) is connectable to a signal output device, such as, e.g., a gaming console or the like, by a wired connection to receive the wired or wireless electrical signal input.

In this regard, the controller (130) includes a plurality of plugs (132) for connecting with a port of a signal interface of the signal output device.

The plugs (132) include a USB plug, a USB-C plug and an audio jack plug.

Generally, the device (100) also draws power for powering the controller (130) and the actuator assemblies (120; not visible) from the signal output device via the USB-C plug.

The controller (130) includes a dial (134) enabling a user to increase/decrease an intensity of the haptic signal generated.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A haptic feedback device for use with a chair for generating a haptic signal in response to a wired or wireless electrical signal input, said device comprising:
a planar body including a front surface and an opposed rear surface, said body configured to rest on at least a backrest of the chair and interface an engagement between the chair and an occupant;
a plurality of electric actuator assemblies embedded in, and arranged across and along, the planar body and configured to translate the electric signal input into the haptic signal, each assembly of said plurality including an electric actuator, an actuator housing including a rear housing portion configured to face a rear surface of the planar body, an opposed front housing portion configured to face a front surface of the planar body and an enlarged flange portion extending or protruding outwardly from the front housing portion for facilitating transfer of the haptic signal to the occupant via the front surface, said portion extending vast sidewalls of the front housing portion in an orthogonal orientation relative to the sidewalls; and
a controller operatively associated with the plurality of electric actuator assemblies for control of the haptic signal generated in response to the wired or wireless electrical signal input.

2. The haptic feedback device of claim 1, wherein the planar body is a substantially flexible structure configured to in use fit to at least the backrest of the chair and be rolled or folded when stowed.

3. The haptic feedback device of claim 2, wherein the planar body further includes a removable cover for covering an internal core of the body.

4. The haptic feedback device of claim 1, wherein the planar body is configured to be fastened to the chair with one or more fasteners.

5. The haptic feedback device of claim 1, wherein the planar body is configured to be releasably mounted to the chair by a loop, strap or band configured to be at least partially wound or wrapped around or about the backrest of the chair.

6. The haptic feedback device of claim 1, wherein the electric actuator is selected from any one of an eccentric rotating mass (ERM), a linear resonant actuator (LRA), a piezo haptic actuator, a thermoelectric device, a solenoid actuator and an ultrasonic transducer or sensor.

7. (canceled)

8. The haptic feedback device of claim 1, wherein both the rear housing portion and the front housing portion each include a rectangular-shaped base, a rim and four sidewalls extending from the base to the rim, and wherein the rear housing portion and the front housing portion are connected together in a rim-to-rim arrangement to form the housing.

9. (canceled)

10. The haptic feedback device of claim 8, wherein the enlarged flange portion includes a plate extending across and along an outer surface of the base of the front housing portion.

11. The haptic feedback device of claim 8, wherein the flange portion extends at least partway around and outwardly from the sidewalls in an orthogonal orientation relative to the sidewalls.

12. (canceled)

13. The haptic feedback device of claim 1, wherein the front surface of the planar body includes a plurality of pre-formed pockets defined thereon each for receiving one of the plurality of electric actuator assemblies therein, said pockets being arranged in discrete locations on the planar body.

14. The haptic feedback device of claim 13, wherein the plurality of pre-formed pockets are sized and shaped such that the enlarged flange portions of respective assemblies received therein lie substantially flush with the front surface of the planar body.

15. The haptic feedback device of claim 1, wherein the controller includes one or more keys, buttons, switches and/or dials for a user to control operation of the device.

16. The haptic feedback device of claim 1, wherein the controller includes at least one display for displaying operational data from the device.

17. The haptic feedback device of at, claim 1, wherein the controller is operatively associated with each of the plurality of electric actuator assemblies by a wired connection.

18. The haptic feedback device of claim 1, wherein the controller further includes at least one plug for connecting with a port of a signal interface of the signal output device.

19. (canceled)

20. A method of using a haptic feedback device with a chair, said method including:
providing a haptic feedback device in accordance with claim 1;
mounting the planar body of the device to at least a backrest of the chair such that the body interfaces an engagement between the chair and an occupant;
generating one or more haptic signals in response to a wired or wireless electrical input signal with a plurality of electric actuator assemblies embedded in, and arranged across and along, the planar body; and
optionally, controlling the one or more haptic signals generated by way of a controller operatively associated with the plurality of electric actuator assemblies.

21. The method of claim 20, wherein the generating includes causing the plurality of electric actuator assemblies to selectively actuate in response to the wired or wireless electrical input signal.

22. The method of claim 20, wherein the controlling includes adjusting an intensity of the haptic signal generated.

23. The method of claim 22, wherein the controlling includes selecting the electric actuator assemblies to generate the haptic signal.
